(19) United States
(12) Patent Application Publication
(10) Pub. No.: US 2009/0278994 A1
(43) Pub. Date: Nov. 12, 2009

(54) METHOD AND SYSTEM FOR AN INTEGRATED MULTI-STANDARD AUDIO/VIDEO RECEIVER

(76) Inventor: Brima Ibrahim, Aliso Viejo, CA (US)

Correspondence Address: MCANDREWS HELD & MALLOY, LTD, 500 WEST MADISON STREET, SUITE 3400, CHICAGO, IL, 60661, US

(21) Appl. No.: 12/119,243

(22) Filed: May 12, 2008

(51) Int. Cl. H04N 5/46

(52) U.S. Cl. 348/729; 348/E05.114

(57) ABSTRACT

Aspects of a method and system for an integrated multi-standard audio and/or video receiver are provided. In this regard, a single audio/video receiver chip may be enabled to receive and process signals adhering to plurality of terrestrial digital audio and/or video standards, and the chip may be configurable based on a format of a desired signal. Exemplary standards may comprise FM broadcast, FM HD, DAB, DAB+, DVB-H, ISDB-T, and DMB-T. One or more RF processing paths and/or one or more baseband processing paths may be configured based on, for example, a frequency of a received signal, a geographical location in which the chip is operated, a modulation scheme of a received signal, and/or the type of information being received. The chip may be configured via software, firmware, and/or manually.

### CROSS-REFERENCE TO RELATED APPLICATIONS/INCORPORATION BY REFERENCE

Not applicable.

### FIELD OF THE INVENTION

Certain embodiments of the invention relate to signal processing. More specifically, certain embodiments of the invention relate to a method and system for an integrated multi-standard audio and/or video receiver.

### BACKGROUND OF THE INVENTION

Portable and/or handheld electronic devices are increasingly utilized for multimedia applications. Accordingly, demands for improved quality and/or performance of multimedia applications on handheld and/or portable devices are presenting system designers with a number of challenges. In this regard, multiple standards and protocols exist for the transmission of audio and video including FM radio, FM-HD radio, DAB, DVB-H, ISDB-T, and DMB-T.

Although FM broadcast radio is dated and lacks capabilities of many newer technologies, FM broadcast radio is still popular. Accordingly, there is significant demand for portable and/or handheld devices with an integrated FM broadcast radio receiver. However, integrating FM broadcast reception capabilities into portable and/or handheld devices presents a number of challenges not seen in traditional FM broadcast radio receivers.

FM-HD or “HD radio” is a technology that allows radio stations to transmit compressed digital audio and traditional analog audio on a common frequency band.

Digital Audio Broadcasting (DAB and/or DAB+), utilized in several countries in Europe among other places, is a technology for broadcasting digital radio. DAB+ (an upgrade to the original DAB which was developed in the 1980's) improves on DAB by, among other things, utilizing AAC encoding and increased error correction coding.

Digital Video Broadcasting-handheld (DVB-H) is a superset of the original DVB standards for broadcasting terrestrial television. The DVB-H standard has been developed for bringing broadcast services to mobile devices such as cell phones and laptops.

Integrated Services Digital Broadcasting-Terrestrial (ISDB-T) is a standard for broadcasting digital content. Various features of ISDB-T make it well suited for reception by mobile devices such as cell phones and laptop computers.

Digital Multimedia Broadcast-Terrestrial (DMB-T) is a digital terrestrial television standard utilized to broadcast digital content. The standard is intended for providing broadcast services to both fixed and mobile devices.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for an integrated multi-standard audio and/or video receiver, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is diagram illustrating an exemplary portable and/or handheld device enabled to receive signals via a plurality of transmission technologies and/or standards which may comprise FM, FM-HD, DAB and/or DAB+, DVB-H, ISDB-T, and DMB-T in accordance with an embodiment of the invention.

FIG. 2 is a diagram illustrating exemplary frequency bands utilized for transmitting FM Broadcast, FM-HD, DAB and/or DAB+, DVB-H, ISDB-T, and DMB-T signals, in connection with an embodiment of the invention.

FIG. 3A is a block diagram of an exemplary RF front end for multi-standard audio and/or video reception, in accordance with an embodiment of the invention.

FIG. 3B is a block diagram of an exemplary RF front end for multi-standard audio and/or video reception, in accordance with an embodiment of the invention.

FIG. 4 is a block diagram of exemplary digital processing subsystem for processing signals received in a multi-standard Audio and/or Video receiver, in accordance with an embodiment of the invention.

FIG. 5 is a block diagram illustrating an exemplary wireless device, in accordance with an embodiment of the invention.

### DETAILED DESCRIPTION OF THE INVENTION

Certain embodiments of the invention may be found in a method and system for an integrated multi-standard audio and/or video receiver. In this regard, a single audio/video receiver chip may be enabled to receive and process signals adhering to FM broadcast, FM HD, DAB, DAB+, DVB-H, ISDB-T, and DMB-T wireless standards, for example, and the chip may be configurable to support said FM broadcast, FM HD, DAB, DAB+, DVB-H, ISDB-T, and DMB-T wireless standards. One or more RF processing paths and/or one or more baseband processing paths may be configured based on, for example, a frequency of a received signal, a geographical location in which the chip is operated, a modulation scheme of a received signal, and/or the type of information being received. The chip may be configured via software, firmware, and/or manually.

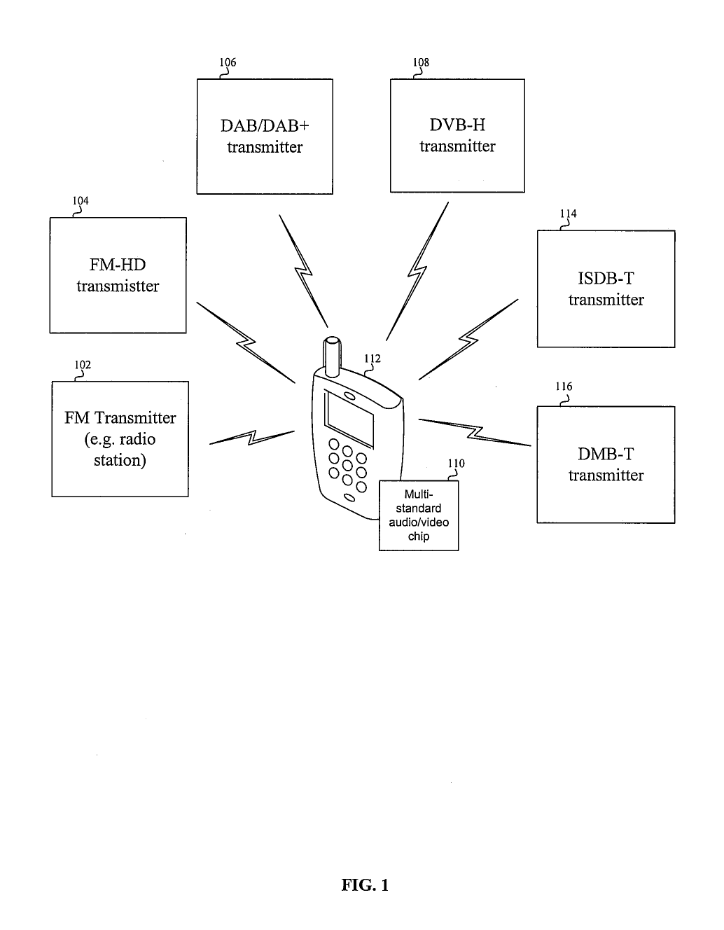

FIG. 1 is diagram illustrating an exemplary portable and/or handheld device enabled to receive signals via a plurality of transmission technologies and/or standards which may comprise FM, FM-HD, DAB and/or DAB+, DVB-H, ISDB-T, and DMB-T in accordance with an embodiment of the invention. Referring to FIG. 1 there is shown a portable and/or handheld wireless communication device 112 comprising a multi-standard audio and/or video receiver chip 110 which may receive audio and/or video transmissions from a FM Broadcast transmitter 102, an FM-HD transmitter 104, a DAB and/or DAB+ transmitter 106, a DVB-H transmitter 108, a ISDB-T transmitter 114, and a DMB-T transmitter 116.

The FM Broadcast transmitter 102 may comprise suitable logic, circuitry, and/or code that may enable transmitting audio and or RDS data. For example, the FM broadcast transmitter may be a terrestrial FM radio station.

The FM-HD transmitter 104 may comprise suitable logic, circuitry, and/or code that may enable transmitting digital and/or hybrid digital audio and/or data. For example, the FM-HD transmitter 104 may be a terrestrial FM radio station in the United States.

The DAB and/or DAB+ transmitter 106 may comprise suitable logic, circuitry, and/or code that may enable transmitting all digital audio and/or data. In this regard, the DAB and/or DAB+ transmitter 106 may be a terrestrial radio station in Europe.

The DVB-H transmitter 108 may comprise suitable logic, circuitry, and/or code that may enable transmitting multimedia content. In this regard, the DVB-H transmitter 108 may be a terrestrial television station.

The ISDB-T transmitter 114 may comprise suitable logic, circuitry, and/or code that may enable transmitting multimedia content. In this regard, the ISDB-T transmitter 114 may be a terrestrial television station.

The DMB-T transmitter 116 may comprise suitable logic, circuitry, and/or code that may enable transmitting multimedia content. In this regard, the DMB-T transmitter 116 may be a terrestrial television station.

The wireless device 112 may comprise suitable logic, circuitry, and/or code that may enable receiving, processing, rendering, and/or presenting audio, video, multimedia, and/or data transmitted via an FM broadcast radio transmitter, an FM-HD transmitter, a DAB and/or DAB+ transmitter, a DVB-H transmitter, a ISDB-T transmitter 114, or a DMB-T transmitter 116. In this regard, the wireless device 102 may be configurable via hardware, firmware, and/or software for selecting the type of audio and/or video transmissions to receive. Thus, the wireless device 112 may comprise a configurable RF front end and/or digital signal processing subsystem and may be enabled to tune, down-convert, demodulate, filter, convert from analog to digital, and process received digital data. In this regard, the wireless device 112 may comprising a multi-standard audio/video chip 110 which may comprise at least a portion of the RF front-end and/or the digital signal processing subsystem. Moreover, logic, circuitry, and/or code in the multi-standard audio/video chip 110 may be shared and/or re-used for processing the various multimedia transmission standards and/or protocols.

In operation, the wireless device 112 (or a user thereof) may select a desired transmission from FM, FM-HD, DAB and/or DAB+, DVB-H, ISDB-T, and DMB-T standards/protocols. Consequently, the multi-standard audio and/or video receiver chip 110 may be configured for the desired standard and/or protocol. Additionally, various components of the chip 110 may be tuned and/or configured to receive a desired channel. The received signal may be down-converted, demodulated, filtered, converted to digital, and conveyed to a digital signal processing block. The digital data may then be decompressed, decoded, and presented to the user. For example, audio may be presented to the user via one or more speakers and video may be presented to the used via a liquid crystal display.

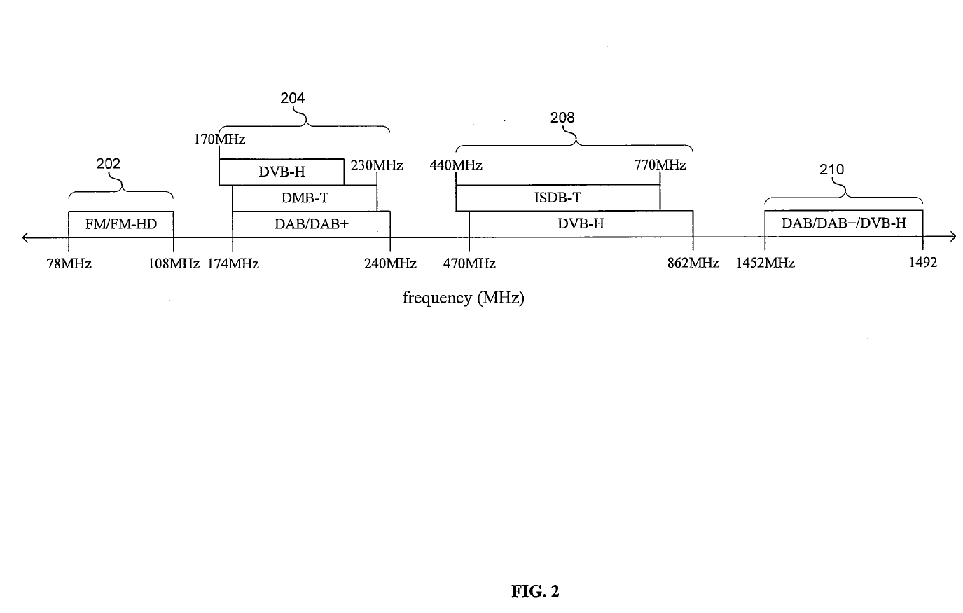

FIG. 2 is a diagram illustrating exemplary frequency bands utilized for transmitting FM Broadcast, FM-HD, DAB and/or DAB+, DVB-H, ISDB-T, and DMB-T signals, in connection with an embodiment of the invention. Referring to FIG. 2 there is shown frequency bands 202, 204, 208, and 210.

The FM broadcast and the FM-HD signals may be transmitted on the frequency band 202. In this regard, the geographical location in which the signals are transmitted may, at least in part, determine the frequency band on which FM and/or FM-HD is transmitted.

The DAB and/or the DAB+ signals may be transmitted in the frequency bands 204 and/or 210. In this regard, geographical location and transmission type, for example terrestrial or satellite, may, at least in part, determine the frequency band on which DAB and/or DAB+ signal may be transmitted.

The DVB-H signals may be transmitted in the frequency bands 204, 208 and/or 210. In this regard, geographical location may, at least in part, determine the frequency band on which DVB-H signals may be transmitted.

The ISDB-T signals may be transmitted in the frequency band 208. In this regard, geographical location may, at least in part, determine the frequency band on which ISDB-T signals may be transmitted.

The DMB-T signals may be transmitted in the frequency band 204. In this regard, geographical location may, at least in part, determine the frequency band on which DMB-T signals may be transmitted.

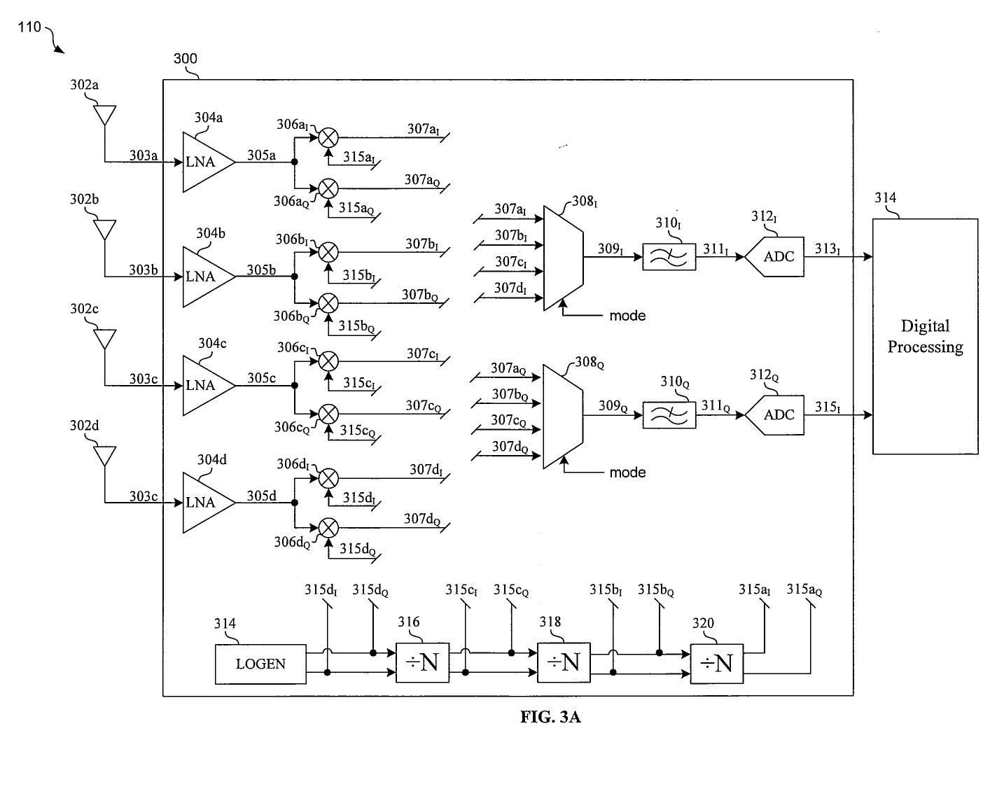

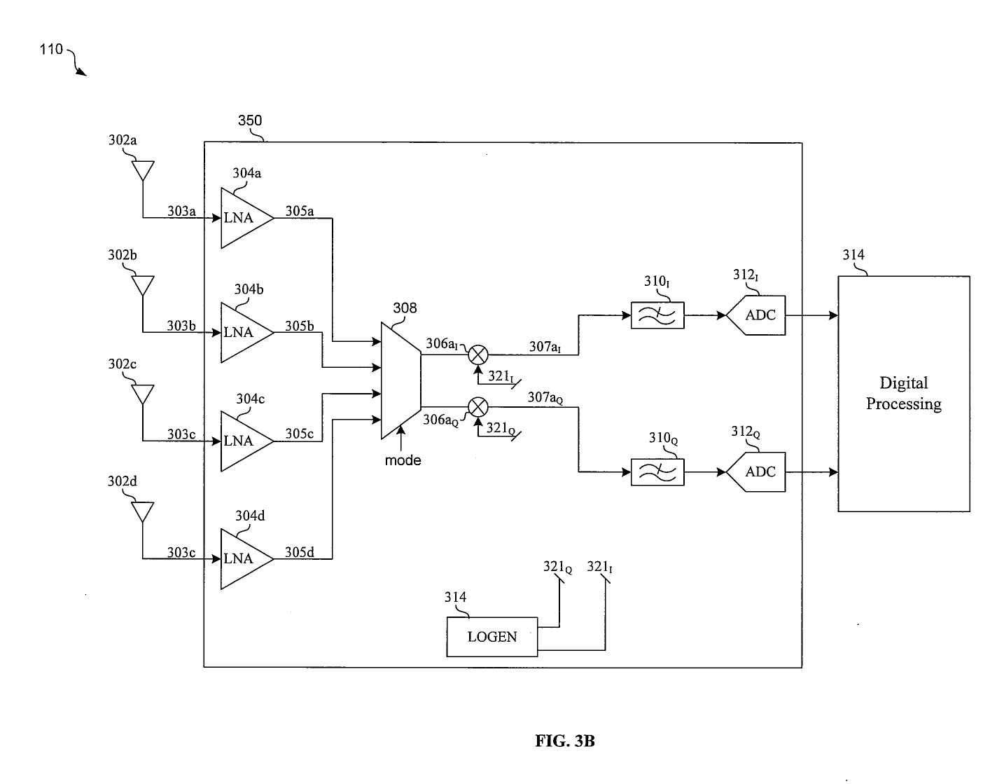

FIG. 3A is a block diagram of an exemplary RF front end for multi-standard audio and/or video reception, in accordance with an embodiment of the invention. Referring to FIG. 3A there is shown details of an exemplary single chip audio/video receiver 110. In this regard, the chip 110 may comprise low noise amplifiers (LNAs) 304, mixers 306, multiplexers 308, filters 310, analog-to-digital (ADC) converters 312, local oscillator generator (LOGEN) 314, a digital processing subsystem 314, and frequency dividers 316, 318, 320. Antennas 302a, 302b, 302c, and 302b, may be communicatively coupled to the chip 110.

The antennas 302 may comprise suitable logic, circuitry, and/or code for receiving signals from FM broadcast, FM-HD, DAB and/or DAB+, DVB-H, ISDB-T, and DMB-T transmitters, such as the transmitters 102, 104, 106, 108, 114, and 116 described with respect to FIG. 1. In various embodiments of the invention there may be a single antenna and/or multiple antennas. For example, the system may comprise a plurality of antennas with each antenna utilized for a specific transmission technology and/or standard.

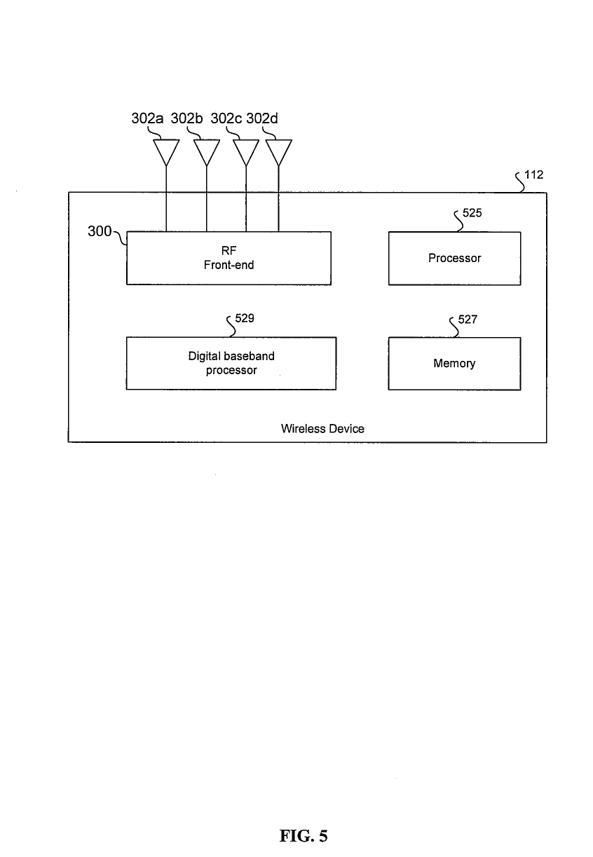

The LNAs 304a, 304b, 304c, 304d (collectively referred to herein as 304) may each comprise suitable logic, circuitry, and/or code that may enable buffering and/or amplification of received RF signals. In this regard, the gain of each LNA 304 may be adjustable to enable reception of signals of varying strength. Accordingly, each LNA 304 may, for example, receive one or more control signals from the processor 525 and/or the baseband processor 529 described with respect to FIG. 5.

The mixers 306a_{I}, 306b_{I}, 306c_{I}, 306d_{I}, 306a_{Q}, 306b_{Q}, 306c_{Q}, 306d_{Q} (collectively referred to herein as 306) may each comprise suitable logic, circuitry, and/or code that may enable generation of inter-modulation products resulting from mixing signals 305 and the local oscillator signals 315. Specifically, each of the channels ‘a’ through ‘d’ may comprise a mixer for an in-phase (I) path and a quadrature-phase (Q) path. In this manner, received signals may be down-converted to phase-quadrature baseband signals 307.

The multiplexers 308, may comprise suitable logic, circuitry, and/or code that may enable selecting one of the signals 307a_{I}, 307b_{I}, 307c_{I}, 307d_{I} for routing to the filter 310_{I} based on a value of the mode signal. Similarly, the multiplexers 308_{Q} may comprise suitable logic, circuitry, and/or code that may enable selecting one of the signals 307a_{Q}, 307b_{Q}, 307c_{Q}, 307d_{Q} for routing to the filter 310_{Q} based on a value of the mode signal.

The filters 310, and 310_{Q}, collectively referred to herein as 310, may each comprise suitable logic, circuitry, and/or code for attenuating undesired frequencies to a greater extent than desired frequencies. In this regard, the filters 310 may each, for example, have low pass or bandpass characteristics. In this manner, the filters may be enabled to reject undesired inter-modulation products output by the mixers 306 while passing desired inter-modulation products.

The ADCs 312_{I} and 312_{Q} may each comprise suitable logic, circuitry, and/or code that may enable conversion of analog signals to a digital representation. In this regard, the ADCs 312_{I} and 312_{Q} may, for example, sample and quantize analog signal 311_{I} and 311_{Q}, respectively, at times specified by a sample clock. Accordingly, the ADCs 311_{I} and 311_{Q} may receive one or more control signals from, for example, the processor 525 or the local oscillator generator 314.

The LOGEN 314 may comprise suitable logic, circuitry, and/or code that may enable generation of at least a pair of phase-quadrature local oscillator signals. For example, the LOGEN 314 may comprise a voltage controlled oscillator for generating a LO frequency and a phase splitter for generating a pair of phase quadrature signals. In various other embodiments of the invention, the LOGEN 314 may comprise a direct digital frequency synthesizer and/or one or more phase locked loops (PLLs). The LOGEN 314 may receive one or more control signals from, for example, the processor 525 or the baseband processor 529 as described with respect to FIG. 5.

The digital processing subsystem 314 may comprise suitable logic, circuitry, and/or code that may enable processing digital data received via FM, FM-HD, DAB and/or DAB+, DVB-H, ISDB-T, and DMB-T transmissions. In this regard, the digital processing subsystem 314 may demodulate, decode, decompress, decrypt, and/or otherwise process the digitized received data.

The frequency dividers 316, 318, and 320 may each comprise suitable logic, circuitry, and/or code that may enable receiving an input frequency and outputting one or more signals lower in frequency by a factor of 1/N. In this regard, the frequency dividers 316, 318, and 320 may be configurable such that the value of N may be determined based on the input frequency and a desired output frequency. In this regard, the frequency dividers 316, 318, and 320 may receive one or more control signals from, for example, the processor 525 and/or the baseband processor 529 described with respect to FIG. 5.

In an exemplary embodiment of the invention, channel ‘a’ may be utilized to receive the frequency band 202 (FIG. 2), channel ‘b’ may be utilized to receive frequency band 204 (FIG. 2), channel ‘c’ may be utilized to receive frequency band 206 (FIG. 2), and channel d′ may be utilized to receive frequency band 210 (FIG. 2).

In operation the antennas 302 may receive RF signals in one of the frequency bands described with respect to FIG. 2. The received signals may be amplified and/or buffered by the LNAs 304 to generate the RF signals 305. In this regard, the gain of each LNA may be adjusted based on the strength of the signal from the coupled antenna. In this manner, each of the signals 305 may be within determined limits, simplifying the design of downstream components such as the mixers 306. Subsequently, the RF signals 305 may be mixed with LO signals 315 to generate baseband signals 307. In this regard, the LOGEN may be tuned and/or programmed to generate an appropriate LO frequency for down converting a desired frequency band. Accordingly, by utilizing frequency dividers 316, 318, and 320, aspects of the invention may enable generating a wide range of LO frequencies with only a single LOGEN circuit. Furthermore, in various embodiments of the invention, a plurality of the channels ‘a’ through ‘d’ may be received simultaneously.

The baseband signals 307 coupled to the filters 310 may be determined based on the value of the “mode” signal. In this regard, the mode signal may be enabled to select the desired frequency band, and thus the desired receive channel ‘a’, ‘b’, ‘c’, or ‘d’. For example, channel ‘a’ may be selected when FM broadcast or FM-HD is desired, channel ‘b’ or ‘d’ (depending, for example, on geographical location) may be selected when DAB and/or DAB+ is desired; channel ‘b’, ‘c’, or ‘d’ (depending, for example, on geographical location) may be selected when DVB-H is desired, channel ‘b’ may be selected when DMB-T is desired, and channel ‘c’ may be selected when ISDB-T is desired.

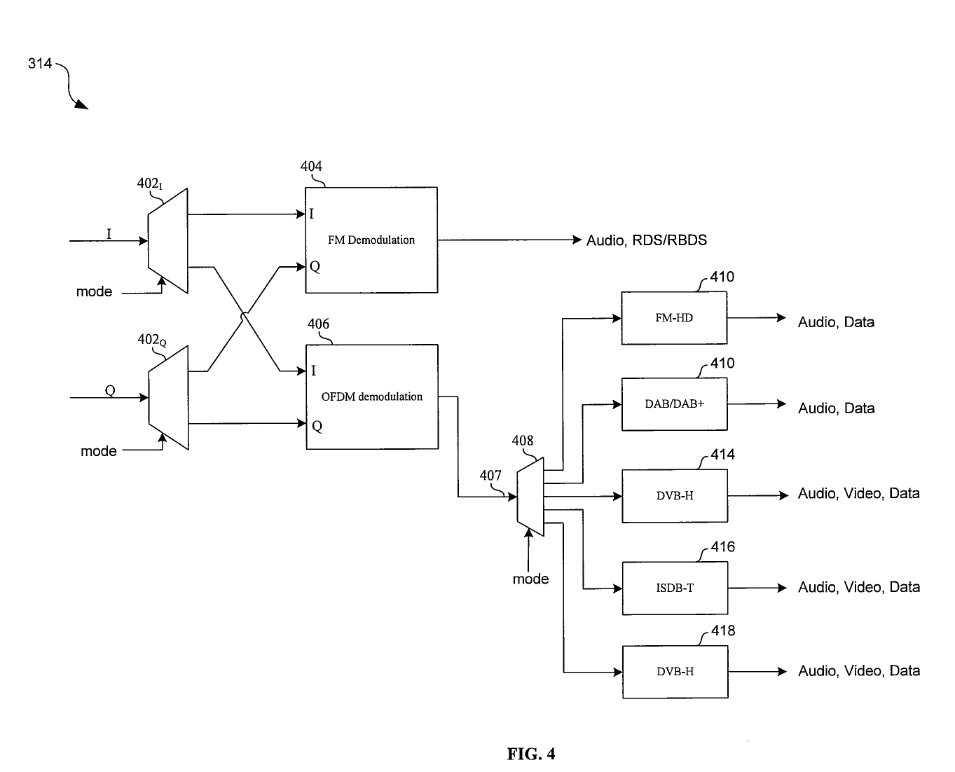

The output of the multiplexer 308, may be communicatively coupled to filter 310_{I} and the in-phase baseband signal 309_{I} may be filtered to generate 311_{I}. Similarly, the output of the multiplexer 308_{Q} may be communicatively coupled to filter 310_{Q} and the quadrature-phase baseband signal 309_{Q} may be filtered to generate 311_{Q}. Signals 311 may then be converted to digital representations and conveyed to the digital processing subsystem 314. Details of the digital processing subsystem are described below with respect to FIG. 4.

In various embodiments of the invention, a wireless device, such as the device 112, may comprise one or more additional front-ends (or components and/or blocks comprising the front end), such that the device may be enabled to receive multiple transmissions simultaneously. For example, another pair of multiplexers may be communicatively coupled to an additional pair of filters and ADCs, and the digital processing subsystem may be enabled to handle two digital streams.

FIG. 3B is a block diagram of an exemplary RF front end for multi-standard audio and/or video reception, in accordance with an embodiment of the invention. The front end 350 in FIG. 3B may be similar to the front end 300 depicted in FIG. 3A, but with the multiplexer moved up stream from the mixers such that only a single pair of mixers may be necessary to down-convert the various frequency bands. In this regard, the front end of FIG. 3B may realize space and cost savings over the front end depicted in FIG. 3A, however, the mixers in the system 350 may have to operate over a wider frequency range. Other embodiments of the invention may utilize different numbers and/or configurations of multiplexers and mixers without deviating from the scope of the present invention.

FIG. 4 is a block diagram of exemplary digital processing subsystem for processing signals received in a multi-standard Audio and/or Video receiver, in accordance with an embodiment of the invention. Referring to FIG. 4 there is shown decoders 402_{I} and 402_{Q}, FM demodulator 404, OFDM demodulator 406, demultiplexer 408, FM HD processing block 410, DAB and/or DAB+ processing block 412, DVB-H processing block 414, ISDB-T processing block 416, and DMB-T processing block 418.

The demultiplexer 402_{I} may comprise suitable logic, circuitry, and/or code that may enable routing of the in-phase digital signal (I) to either the FM demodulator 404 and/or the OFDM demodulator 406 based on a value of the mode signal. Similarly, the demultiplexer 402_{Q} may comprise suitable logic, circuitry, and/or code that may enable routing the quadrature-phase digital signal (Q) to either the FM demodulator 404 and/or the OFDM demodulator 406 based on a value of the mode signal.

The FM demodulator 404 may comprise suitable logic, circuitry, and/or code for detecting and/or extracting information frequency modulated onto the received signal. In this manner, the FM demodulator 404 may output, for example, audio and/or RDS information contained in the I and Q signals.

The orthogonal frequency division multiplexing (OFDM) demodulator 406 may comprise suitable logic, circuitry, and/or code for detecting and/or extracting information from OFDM modulated signals. In this regard, the OFDM demodulator 406 may output baseband FM HD, DAB and/or DAB+, and DVB-H signals.

The demultiplexer 408 may comprise suitable logic, circuitry, and/or code that may enable routing the demodulated digital signal 407 to the FM HD processing block 410, the DAB and/or DAB+ processing block 412, and/or the DVB-H processing block 414, based on a value of the mode signal.

The FM HD processing block 410 may comprise suitable logic, circuitry, and/or code for decoding, decompressing, and/or otherwise processing baseband digital audio signals formatted in accordance with FM HD standards/protocols. In this manner, the FM HD processing block 410 may render and/or present received audio and/or data.

The DAB and/or DAB+ processing block 412 may comprise suitable logic, circuitry, and/or code that may enable decoding, decompressing, and/or otherwise processing baseband digital audio signals formatted in accordance with DAB and/or DAB+ standards/protocols. In this manner, the DAB and/or DAB+ processing block 412 may render and/or present received audio and/or data.

The DVB-H processing block 414 may comprise suitable logic, circuitry, and/or code for decoding, decompressing, and/or otherwise processing baseband digital audio and/or video signals formatted in accordance with DVB-H standards/protocols. In this manner, the DVB-H processing block 414 may render and/or present received audio, video, and/or data.

The ISDB-T processing block 416 may comprise suitable logic, circuitry, and/or code for decoding, decompressing, and/or otherwise processing baseband digital audio and/or video signals formatted in accordance with ISDB-T standards/protocols. In this manner, the ISDB-T processing block 416 may render and/or present received audio, video, and/or data.

The DMB-T processing block 418 may comprise suitable logic, circuitry, and/or code for decoding, decompressing, and/or otherwise processing baseband digital audio and/or video signals formatted in accordance with ISDB-T standards/protocols. In this manner, the DMB-T processing block 418 may render and/or present received audio, video, and/or data.

In operation, digitized quadrature-phase signals I and Q may be received from an RF front end such as the front end 300 or 305 depicted in FIG. 3a or 3B. For FM reception, the mode signal may route the signals to the FM demodulator and subsequently FM audio and/or data may be output by the FM demodulator 404. Alternatively, I and Q may be routed to the OFDM demodulator 406 which may demodulate I and Q to output a baseband signal 407. For FM HD reception, the baseband signal 407 may be routed to the FM HD processing block 410, which may process the baseband signal to make it suitable for presentation. For DAB and/or DAB+ reception, the baseband signal 407 may be routed to the DAB and/or DAB+ processing block 412, which may process the baseband signal to make it suitable for presentation. For DVB-H reception, the baseband signal 407 may be routed to the DVB-H processing block 414, which may process the baseband signal to make it suitable for presentation. For ISDB-T reception, the baseband signal 407 may be routed to the ISDB-T processing block 416, which may process the baseband signal to make it suitable for presentation. For DMB-T reception, the baseband signal 407 may be routed to the DMB-T processing block 418, which may process the baseband signal to make it suitable for presentation.

FIG. 5 is a block diagram illustrating an exemplary wireless device, in accordance with an embodiment of the invention. Referring to FIG. 5 there is shown a portable and/or handheld wireless device 112.

The wireless device 112 may comprise an RF front end 300, a digital baseband processor 529, a processor 525, and a memory 527. A plurality of receive antennas 302a, 302b, 302c, and 302d may be communicatively coupled to the RF front end 300. In this regard, all or a portion of the front end 300, baseband processor 529, processor 525, and the memory 527 may be realized on a single chip audio/video receiver similar to or the same as the chip 110 of FIG. 1.

The RF front end 300 may comprise suitable logic, circuitry, and/or code that may enable receiving and processing audio, video, and/or data formatted and/or transmitted according to FM broadcast radio, FM-HD, DAB and/or DAB+, DVB-H, ISDB-T, and/or DMB-T protocols and/or standards. The RF front end 300 may enable receiving of RF signals in a plurality of frequency bands. For example, the RF receiver 523a may enable receiving signals in one or more of the frequency bands 202, 204, 208, and/or 210 depicted in FIG. 2. In this regard, the RF front end 300 may be as described with respect to FIGS. 3A and 3B and may be referred to as a multi-band receiver. In various embodiments of the invention, the wireless device 112 may comprise more than one RF front end and may thus simultaneously receive multiple audio and/or video transmission formats and/or standards.

The digital baseband processor 529 may comprise suitable logic, circuitry, and/or code that may enable processing and/or handling of baseband signals. In this regard, the digital baseband processor 529 may process or handle signals received from the RF front end 300. In this regard, the digital processor may be similar to or the same as, or comprise the digital processing block 314 and/or one or more of the blocks depicted in FIG. 4. The digital baseband processor 529 may also provide control and/or feedback information to the RF front end 300 based on information from processed signals. For example, the digital baseband processor 525 may provide one or more control signals to configure the multiplexers 308, the LNAs 304, the mixers 306, the LOGEN 314, the frequency dividers 316-320, the filters 310, and/or the ADCs 312. The digital baseband processor 529 may communicate information and/or data from the processed signals to the processor 525 and/or to the memory 527. Moreover, the digital baseband processor 529 may receive information from the processor 525 and/or to the memory 527, which may be processed and transferred to the front end 300.

The processor 525 may comprise suitable logic, circuitry, and/or code that may enable control and/or data processing operations for the wireless device 112. The processor 525 may be utilized to control at least a portion of the RF front end 300, the digital baseband processor 529, and/or the memory 527. In this regard, the processor 525 may generate at least one signal for controlling operations within the wireless device 112. For example, the digital baseband processor 525 may provide one or more control signals to configure the multiplexers 308, the LNAs 304, the mixers 306, the LOGEN 314, the frequency dividers 316-320, the filters 310, and/or the ADCs 312. The processor 525 may also enable executing of applications that may be utilized by the wireless device 112. For example, the processor 525 may execute applications that may enable presenting, displaying, and/or interacting with content received via FM, FM-HD, DAB and/or DAB+, and/or DVB-H transmissions in the wireless device 520.

The memory 527 may comprise suitable logic, circuitry, and/or code that may enable storage of data and/or other information utilized by the wireless device 112. For example, the memory 527 may be utilized for storing processed data generated by the digital baseband processor 529 and/or the processor 525. The memory 527 may also be utilized to store information, such as configuration information, that may be utilized to control the operation of at least one block in the wireless device 112. For example, the memory 527 may comprise information necessary to configure the RF front end 300 to enable receiving FM, FM-HD, DAB and/or DAB+, DVB-H, ISDB-T, and/or DMB-T transmissions in an appropriate frequency band.

Various aspects of the invention may provide a method and system for an integrated multi-standard audio/video receiver. In this regard, a single audio/video receiver chip, 110 of FIG. 1, may be enabled to receive and process signals adhering to FM broadcast, FM HD, DAB, DAB+, DVB-H, ISDB-T, and DMB-T wireless standards, and the chip may be configurable to support said FM broadcast, FM HD, DAB, DAB+, DVB-H, ISDB-T, and DMB-T wireless standards. One or more RF processing paths and/or one or more baseband processing paths may be configured based on, for example, a frequency of a received signal, a geographical location in which the chip is operated, a modulation scheme of a received signal, and/or the type of information being received. The chip may be configured via software, firmware, and/or manually.

Another embodiment of the invention may provide a machine-readable storage, having stored thereon, a computer program having at least one code section executable by a machine, thereby causing the machine to perform the steps as described herein for an integrated multi-standard audio and/or video receiver.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
in a single audio/video receiver chip that handles processing of signals formatted in accordance with one or more of a plurality of terrestrial digital video and/or audio standards, receiving one or more said signals; and
configuring one or more RF processing paths within said single audio/video receiver chip, and one or more corresponding baseband processing paths within said single audio/video receiver chip for processing said received signals.

2. The method according to claim 1, comprising configuring said one or more RF processing paths and one or more corresponding baseband processing paths based on a frequency of a received signal.

3. The method according to claim 1, comprising configuring said one or more RF processing paths and one or more corresponding baseband processing paths based on a geographical region in which said single audio/video receiver chip is operated.

4. The method according to claim 1, comprising configuring said RF processing path and said baseband processing path based on a modulation scheme of a received signal.

5. The method according to claim 1, comprising configuring said one or more RF processing paths and one or more corresponding baseband processing paths based on whether reception of audio, video, and/or data is desired.

6. The method according to claim 1, comprising configuring said one or more RF processing paths and one or more corresponding baseband processing paths via logic, circuitry, and/or code.

7. The method according to claim 1, comprising manually configuring said one or more RF processing paths and one or more corresponding baseband processing paths.

8. The method according to claim 1, wherein said plurality of terrestrial digital video and/or audio standards comprises two or more of FM broadcast, FM-HD, DAB, DAB+, DVB-H, ISDB-T, and DMB-T.

9. A machine-readable storage having stored thereon, a computer program having at least one code section for signal processing, the at least one code section being executable by a machine for causing the machine to perform steps comprising:
in a single audio/video receiver chip that handles processing of signals formatted in accordance with one or more of a plurality of terrestrial digital video and/or audio standards, receiving one or more said signals; and
configuring one or more RF processing paths within said single audio/video receiver chip, and one or more corresponding baseband processing paths within said single audio/video receiver chip for processing said received signals.

10. The machine-readable storage according to claim 9, wherein said at least one code section comprises code for configuring said one or more RF processing paths and one or more corresponding baseband paths based on a frequency of a received signal.

11. The machine-readable storage according to claim 9, wherein said at least one code section comprises code for configuring said one or more RF processing paths and one or more corresponding baseband processing paths based on a geographical region in which the single audio/video receiver chip is operated.

12. The machine-readable storage according to claim 9, wherein said at least one code section comprises code for configuring said one or more RF processing paths and one or more corresponding baseband processing paths based on a modulation scheme of a received signal.

13. The machine-readable storage according to claim 9, wherein said at least one code section comprises code for configuring said one or more RF processing paths and one or more corresponding baseband processing paths based on whether reception of audio, video, and/or data is desired.

14. The machine-readable storage according to claim 9, wherein said plurality of terrestrial digital video and/or audio standards comprises two or more of FM broadcast, FM-HD, DAB, DAB+, DVB-H, ISDB-T, and DMB-T.

15. A system for signal processing, the system comprising:
one or more circuits in a single audio/video receiver chip enabled to receive and process signals formatted in accordance with one or more of a plurality of terrestrial digital video and/or audio standards, wherein said one or more circuits enable configuration of said chip to support said plurality of terrestrial digital video and/or audio standards.

16. The system according to claim 15, wherein said one or more circuits comprise one or more RF processing paths.

17. The system according to claim 15, wherein said one or more circuits comprise one or more baseband processing paths.

18. The system according to claim 15, wherein said one or more circuits configure said single audio/video receiver chip based on a frequency of a received signal.

19. The system according to claim 15, wherein said one or more circuits configure said single audio/video receiver chip based on a geographical region in which said single audio/video receiver chip is operated.

20. The system according to claim 15, wherein said one or more circuits configure said single audio/video receiver chip based on a modulation scheme of a received signal.

21. The system according to claim 15, wherein said one or more circuits configure said single audio/video receiver chip based on whether reception of audio, video, and/or data is desired.

22. The system according to claim 15, wherein said one or more circuits are configured via software and/or firmware.

23. The system according to claim 15, wherein said one or more circuits are manually configured.

24. The system according to claim 15, wherein said plurality of terrestrial digital video and/or audio standards comprises two or more of FM broadcast, FM-HD, DAB, DAB+, DVB-H, ISDB-T, and DMB-T.
